(19) United States
(12) Patent Application Publication
(10) Pub. No.: US 2014/0321244 A1
(43) Pub. Date: Oct. 30, 2014

(54) ULTRASONIC WAVE TRANSDUCER USING A SIGNAL PATHWAY-INTEGRATED HOUSING

(71) Applicant: Susung Lee, Gyeonggi-do (KR)

(72) Inventor: Susung Lee, Gyeonggi-do (KR)

(73) Assignee: ALPINION MEDICAL SYSTEMS CO., LTD., Hwaseong-si, Gyeonggi-do (KR)

(21) Appl. No.: 14/369,581

(22) PCT Filed: Dec. 30, 2011
(86) PCT No.: PCT/KR2011/010391

§ 371 Date: Jun. 27, 2014

(30) Foreign Application Priority Data
Dec. 30, 2011 (KR) 10-2011-0147016

(51) Int. Cl. H04R 17/00

(52) U.S. Cl. CPC H04R 17/00
USPC 367/180

(57) ABSTRACT

The present disclosure relates to an ultrasonic wave transducer using a signal pathway-integrated housing. The ultrasonic wave transducer includes: a housing serving as a handle; an array including a plurality of piezoelectric elements disposed in parallel to each other on a back material and a flexible circuit board having a pattern electrically connected to the piezoelectric elements; and a cable assembly including a plurality of fine wires. Signal paths for electrically connecting the pattern circuit of the flexible circuit board to the fine wires are integrated with the housing. Thus, the necessary space within a scanhead can be minimized to improve the degree of freedom in ergonomic design and to provide an ultrasonic wave transducer having a small-sized handle and excellent gripping properties.

### TECHNICAL FIELD

The present disclosure in one or more embodiments relates to an ultrasound transducer. More particularly, the present disclosure relates to an ultrasound transducer employing a housing with an integrated signal path, which enhances the flexibility in designing ergonomic transducers and provides a more compact handle with a better grip, and facilitates shielding of electromagnetic noise.

### BACKGROUND

Ultrasound diagnostic systems emit ultrasound signals from the body surface of a patient towards a target portion inside the body of a patient and extract information from reflected ultrasound signals, thus noninvasively obtaining sectional images of soft tissues or images related to a patient's bloodstream.

Such ultrasound diagnostic systems are small and inexpensive compared to other kinds of diagnostic imaging apparatuses, such as an X-ray apparatus, a CT (computerized tomography) scanner, an MRI (magnetic resonance image) scanner, a nuclear medicine imaging apparatus, etc., and are capable of displaying results in real time, and highly safe because there is no risk of exposing patients to X-ray radiation or the like. Therefore, ultrasound diagnostic systems are widely used to diagnose heart, abdominal internal organs, urinary system, reproductive organ, etc. of a patient.

Such ultrasound diagnostic systems include a transducer which transmits ultrasound signals to the patient's body and receives ultrasound echo signals reflected from the body in order to obtain ultrasound image.

FIG. 1 illustrates an example of an ultrasound transducer according to a conventional technology.

As shown in the drawing, the transducer 100 includes a scanhead 110 which has a housing 111 serving as a handle and an arrayed transducer elements or array 112, a cable assembly 120 which is coupled to an end of the scanhead 110, and a system connector 130 which is coupled to the cable assembly 120 at a position opposite the scanhead 110 and is connected to an ultrasound diagnostic system (not shown).

The cable assembly 120 is used to transmit and receive signals between the scanhead 110 and the ultrasound diagnostic system. An end of the cable assembly 120 is received in the housing 111 of the scanhead 110. A plurality of fine wires 121 of the cable assembly 120 is connected to a PCB (printed circuit board) 122 of the scanhead 110. The fine wires 121 are connected at the other end of the cable assembly 120 to another PCB 132 which is housed in the system connector 130 connected to the ultrasound diagnostic system. For instance, the system connector 130 may be a ZIF type connector. In this example, the system connector 130 can make a ZIF connection by means of rotating a handle 131 that protrudes in a direction opposite to a junction surface of the system connector 130.

FIG. 2 is an exploded perspective view of the scanhead shown in FIG. 1, from which the housing has been removed, showing flexible boards at the array side and the PCB at the cable assembly side which are connected to each other by a pair of connectors. Referring to FIG. 2, as mentioned above, the fine wires 121 provided in the cable assembly 120 are connected to the PCB 122. A pattern circuit that forms signal paths is formed on a surface of the PCB 122. Electrically connected to the pattern circuit, a connector 124 is mounted on the surface of the PCB 122.

Although it is not shown in detail, the array 112 comprises a backing member having a plurality of piezoelectric elements arranged in parallel with excitation electrodes and installed with an acoustic matching layer and another layer of acoustic lens. Filling material may be charged into space between the piezoelectric elements and the acoustic matching layer. The array 112 has, for example the front and rear flexible boards 113 transmit signals to the respective excitation electrodes of the piezoelectric elements.

The flexible circuit board 113 has a surface provided with a pattern circuit that forms the signal paths and is electrically connected to the respective electrodes of the piezoelectric elements. The electrodes of the piezoelectric elements may be commonly connected by a fine metal wire into the ground. A connector 114 is mounted on the flexible circuit board 113 and is electrically connected to the pattern circuit of the flexible circuit board 113. When the connector 114 is coupled to the connector 124 that is electrically connected to the fine wires 121 of the cable assembly 120, a wired connection is made for transmission and reception of signals between the scanhead and the ultrasound diagnostic system.

A user attains desired ultrasound images by manipulating the transducer 100 by the scanhead 110 along the body surface of a patient or by rotating the scanhead 110 while in contact with the patient's body surface.

However, in the conventional ultrasound transducer 100, the electrical connection by the connectors 114 and 124 between the array 112 having the flexible circuit board 113 and the cable assembly 120 having the PCB 122 required the housing 111 to secure a space for receiving at least the flexible circuit board 113, the PCB 122 and the connectors 114 and 124. This has made the scanhead 110 relatively bulky, and in turn made it difficult to provide downsized transducer 100.

Furthermore, spatial restriction in the housing 111 reduces the degree of freedom in ergonomically designing the housing 111 as a limiting factor in providing an optimal design of the transducer.

In addition, long term manipulations of such bulky scanhead 100 are susceptible to impose wrist pain and fatigue to the user, resulting in a poor manipulability of the transducer.

### DISCLOSURE

### Technical Problem

Therefore, the present disclosure has been made to provide an ultrasound transducer which replaces a PCB conventionally provided along with signal paths in a cable assembly with the housing having integrated signal paths, whereby minimizing the necessary space in a scanhead to improve the degree of freedom in ergonomic design and to provide an ultrasound transducer having a small-sized handle enabling a user to conveniently grasp.

The present disclosure further provides an ultrasound transducer using signal paths integrated with the housing which can readily block electromagnetic noise.

### SUMMARY

In accordance with some embodiments of the present disclosure, an ultrasound transducer, including a housing, an array and a cable. The housing is configured to serve as a handle. The array is mounted on a side surface of the housing and has a plurality of piezoelectric elements arranged in parallel to each other on a backing member, and a first flexible circuit board including a pattern circuit electrically connected to the piezoelectric elements. The cable assembly has a plurality of fine wires. Herein, signal paths are integrally formed on the housing for electrically connecting the pattern circuit of the flexible circuit board to the fine wires.

Alternatively, the first flexible circuit board may be provided with a first connector electrically connected to the first pattern circuit, and a second flexible circuit may be adhesively formed on the housing. The second flexible circuit board may have a second pattern circuit electrically connected by the fine wires to form signal paths, and a mating second connector electrically connected to the second pattern circuit.

As a further alternative, the first flexible circuit board may be provided with a first connector electrically connected to the first pattern circuit, and a second pattern circuit may be directly patterned on an inner surface of the housing and electrically connected by the fine wires to form signal paths, and a mating second connector may be mounted on the inner surface of the housing and electrically connected to the second pattern circuit.

### Advantageous Effects

In an ultrasound transducer according to the present disclosure, a signal paths are integrated with a housing of a scanhead so that the necessary space in the scanhead can be minimized to improve the degree of freedom in ergonomic design and to provide an ultrasound transducer having a small-sized handle with excellent grip.

Furthermore, the ultrasound transducer according to the present disclosure can readily block electromagnetic noise.

### DESCRIPTION OF DRAWINGS

FIG. 1 is a view showing an example of an ultrasound transducer according to a conventional technology.

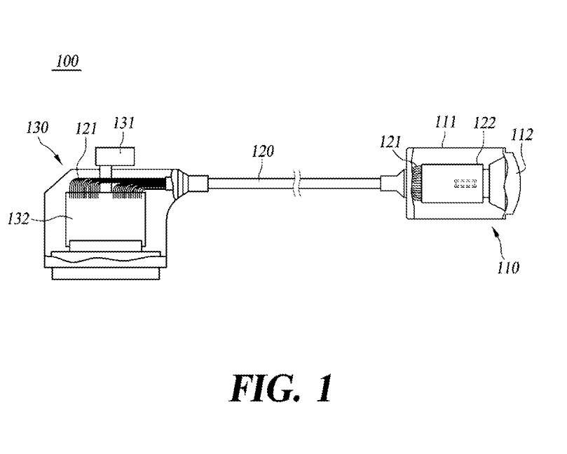

FIG. 2 is an exploded perspective view of a scanhead shown in FIG. 1, from which a housing has been removed, showing flexible boards at an array side and a PCB at a cable assembly side which are connected to each other by a pair of connectors.

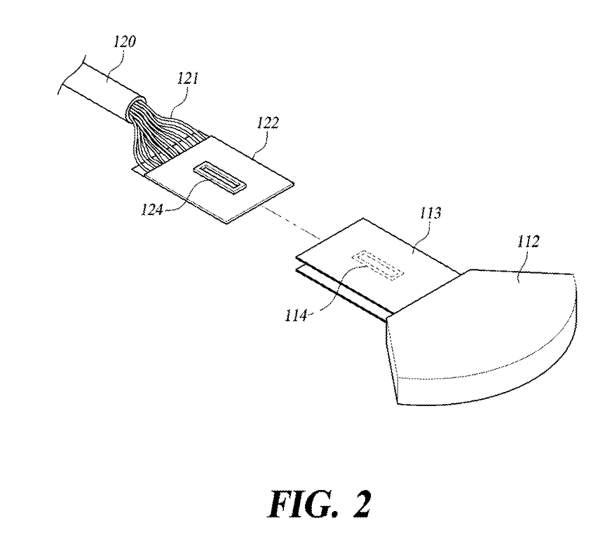

FIG. 3 is a schematic sectional view illustrating a scanhead of an ultrasound transducer according to a first embodiment of the present disclosure.

FIG. 4 illustrates a sectional view taken along line A-A′ of FIG. 3 and an enlarged view of portion B.

FIG. 5 is a schematic sectional view illustrating a scanhead of an ultrasound transducer according to a second embodiment of the present disclosure.

### DETAILED DESCRIPTION

Hereinafter, at least one embodiment of the present disclosure will be described in detail with reference to the accompanying drawings. In the following description, like reference numerals designate like elements although the elements are shown in different drawings. Further, in the following description of the at least one embodiment, a detailed description of known functions and configurations incorporated herein will be omitted for the purpose of clarity and for brevity.

An ultrasound transducer according to the preset disclosure includes a housing, an array and a cable assembly. The housing is configured to serve as a handle. The array is mounted on a side surface of the housing and includes a plurality of piezoelectric elements arranged in parallel to each other on a backing member, and a flexible circuit board including a pattern circuit electrically connected to the piezoelectric elements. The cable assembly has a plurality of fine wires. The ultrasound transducer is characterized in that the housing is formed with integral signal paths for electrically connecting the pattern circuit of the flexible circuit board to the fine wires.

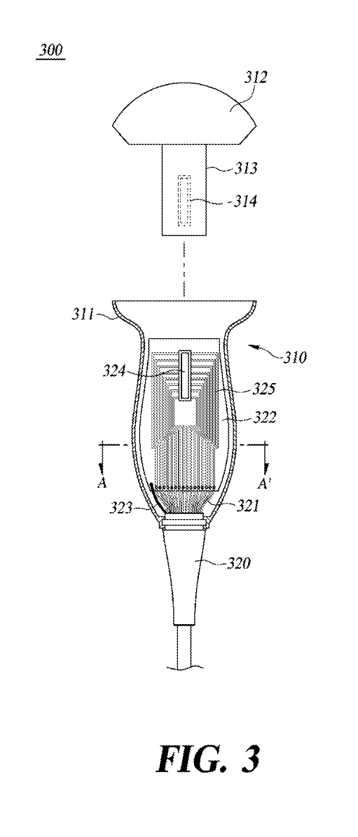

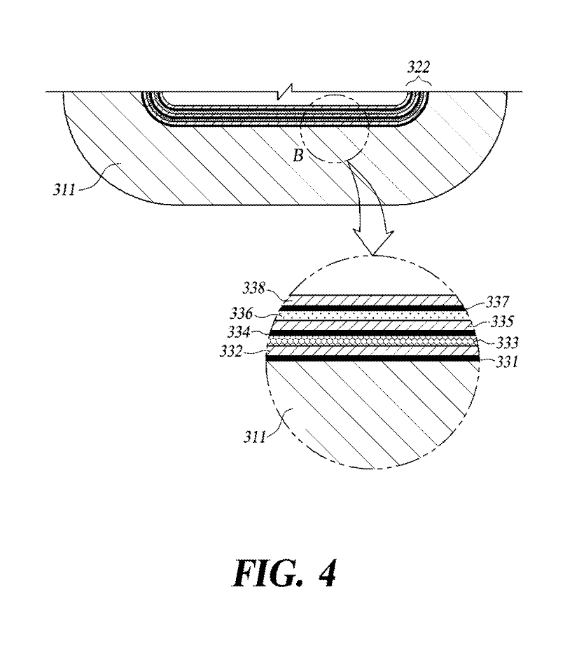

FIG. 3 is a schematic sectional view illustrating a scanhead of an ultrasound transducer according to a first embodiment of the present disclosure. FIG. 4 illustrates a sectional view taken along line A-A′ of FIG. 3 and an enlarged view of portion B.

As shown in these drawings, the ultrasound transducer 300 according to the first embodiment of the present disclosure includes: a housing 311 which serves as a handle; an array 312; and a cable assembly 320. The array 312 is disposed on a side surface of the housing 311 and comprises a plurality of piezoelectric elements (not shown) arranged in parallel to each other on a backing member. The array 312 further includes at least one first flexible circuit board 313 which is provided with a pattern circuit (not shown) electrically connected to the piezoelectric elements and a first connector 314 electrically connected to the pattern circuit. The cable assembly 320 includes a plurality of fine wires 321. The housing is fixed with a second flexible circuit board 322 having a pattern circuit 325 electrically connected to the fine wires 321 to form signal paths and a mating second connector 324 electrically connected to the pattern circuit 325. The second flexible circuit board 322 is adhered to the housing 311.

The housing 311 defines outer contour of a scanhead 310 and is ergonomically designed to enable a user to easily grasp the scanhead 310, that is, the transducer 300 in use. The housing 311 has therein a hollow space for receiving components such as the first flexible boards 313 from the array 312. Particularly, the ultrasound transducer 300 according to the first embodiment of the present disclosure is characterized in that, as detailed below, the housing 311 is integrated with the second flexible circuit board 322 whereby the space in the housing 311 can be minimized to improve the design flexibility and to provide the handle with a compact size and excellent grip feel for a user.

The array 312 has a backing member having the piezoelectric elements arranged in parallel with excitation electrodes and installed with an acoustic matching layer and another layer of acoustic lens. Filling material may be charged into a space between the piezoelectric elements and the acoustic matching layer. The array 312 allows, for example, the front and rear flexible boards 113 to transmit signals to the respective excitation electrodes of the piezoelectric elements. In this disclosure, the array 312 is not illustrated in detail for the sake of illustration, but a single first connector 314 electrically connected to the pattern circuit is described and illustrated as being installed on a surface of the first flexible circuit board 313.

As mentioned above, the second flexible circuit board 322 is integrated with the housing 311. To achieve this, in the ultrasound transducer 300 according to the first embodiment of the present disclosure, the second flexible circuit board 322 is adhered to the housing 311 through an adhesive means, for example, an epoxy adhesive.

The second flexible circuit board 322 includes, but not limited to, a plurality of flexible polyimide films. For example, the second flexible circuit board 322 may include other properly flexible and comparatively strong materials. The metal pattern circuit 325 is formed of a malleable metal (e.g., gold, silver or copper) deposited on a surface of the second flexible circuit board 322 by a known method such as sputtering, plating, etching, etc. Where the thickness and width of a pattern is properly determined, the conductivity of the pattern circuit 325 can be maintained as well with appropriate flexibility and resiliency. This keeps the pattern circuit from being damaged when adhering the second flexible circuit board 322 even to a three-dimensional inner surface of the housing 311.

More specifically, layers forming the second flexible circuit board 322 of the ultrasound transducer 300 according to the first embodiment of the present disclosure will be described with reference to FIG. 4, emphasizing the function of each layer on a positional order of the layers starting from the inner surface of the housing 311.

A first adhesive layer 331 of material such as epoxy adhesive is applied to the plastic inner surface of the housing 311. On the first adhesive layer 331, a first polyimide film 332 is placed on the first adhesive layer 331 to form one side boundary of the second flexible circuit board 322. A copper foil layer 333 is laid on the first polyimide film 332. The copper foil layer 333 serves as a common ground with respect to electric signals and covers the entire area of the first polyimide film 332. In addition, the copper foil layer 333 is configured to shield electromagnetic waves for reducing electromagnetic noise generated during operation of the transducer so as to minimize the interference with other devices and withstand various electromagnetic noises from outside.

A second adhesive layer 334 formed of acryl adhesive or the like is provided on the copper foil layer 333. On the second adhesive layer 334 is a second polyimide film 335 which is then overlaid with a pattern layer 336. The pattern circuit 325 (refer to FIG. 3) is formed in the pattern layer 336 by a method such as etching or the like. As shown in FIG. 3, the pattern circuit 325 electrically connects the first flexible circuit board 313 of the array 312 to the fine wires 321 of the cable assembly 320.

A third adhesive layer 337 formed of acryl adhesive or the like is provided on the pattern layer 336. A third polyimide film 338 is placed on and bonded to the third adhesive layer 337 to form the other side boundary of the second flexible circuit board 322. The third polyimide film 338 is used to electrically and mechanically protect the pattern layer 336. Provided on the third polyimide film 338 is the second connector 324 (refer to FIG. 3) electrically connected to the pattern circuit 325 of the pattern layer 336. Referring to FIG. 3, the connection of the second connector 324 mateable to its first connector 314 of the array 312 enables signals to be transmitted between the first flexible circuit board 313 of the array 312 and the fine wires 321 of the cable assembly 320.

The second flexible circuit board 322 is designed planar conforming to the curvature and shape of the inner surface of the housing 311. Such a design can be easily implemented by use of a known 3D-design tool or the like and, therefore, further explanation thereof will not be provided in this description.

The second flexible circuit board 322 is manufactured through a separate process and then adhered to the housing 311 by an adhesive means, that is, the first adhesive layer 331. Subsequently, the aforementioned second connector 324 and the fine wires 321 of the cable assembly 320 are respectively connected by soldering to the second flexible circuit board 322. For soldering, portions of the pattern layer 336 are exposed through the third polyimide film 338.

Alternatively, after the second flexible circuit board 322 is manufactured through a separate process, the second connector 324 and the fine wires 321 of the cable assembly 320 may be soldered and connected to the second flexible circuit board 322 before conforming and bonding the connected second flexible circuit board 322 to the housing 311.

The cable assembly 320 is formed of the fine wires 321 bundled together and enclosed by a flexible outer sheath of the cable assembly 320. Interposed between the outer sheath and the fine wires 321 is a cylindrical jacket shield (not shown) having electromagnetic shielding characteristics. The jacket shield is grounded and serves to shield the fine wires 321 in the cable assembly 320 from electromagnetic noises. The jacket shield is, for example, a foil or mesh shield made of copper, aluminum, tin-plated copper, silver-plated copper, nickel-plated copper, an alloy or a metalized polymer.

As shown in FIG. 3, in the ultrasound transducer 300 according to the first embodiment of the present disclosure, the jacket shield is partially drawn into a predetermined room to form a protruding jacket shield extension 323 for making an electrical connection by soldering with the copper foil layer 333 (FIG. 4) having been exposed, whereby electromagnetic noise in the housing 311 can be blocked. This obviates the need to secure more space for electromagnetic wave shielding to preclude the spatial restriction involved in the electromagnetic shielding. The result is an enhanced degree of freedom in designing the housing 311.

To sum up, in the second flexible circuit board 322, the copper foil layer 333 is partially exposed for connection to a common ground along with the jacket shield extension 323 of the cable assembly 320, and the pattern layer 336 is also partially exposed for connection to the second connector 324. The remainder of the second flexible circuit board 322 besides the exposed portions is coated with an insulator, for example, a polyimide film, to prevent an electrical short.

Coupling of the connector 314 on the first flexible circuit board 313 of the array 312 to the mating second connector 324 on the second flexible circuit board 322 integrated with the housing 311 completes the wire connection to allow transmission of signals between the first flexible circuit board 313 of the array 312 and the fine wires 321 of the cable assembly 320.

As described above, the ultrasound transducer 300 according to the first embodiment of the present disclosure provides the second flexible circuit board 322 of the cable assembly 320 integrally with the housing 311 to markedly enhance the degree of freedom in designing the length, width, thickness and shape of the housing 311 and thereby implement the ultrasound transducer with a smaller and optimal handle grip. Moreover, an extra ergonomical design of the housing can further prevent wrist pain and fatigue even after a long-term manipulation of the final ultrasound transducer which provides an exceptional precise and fine control.

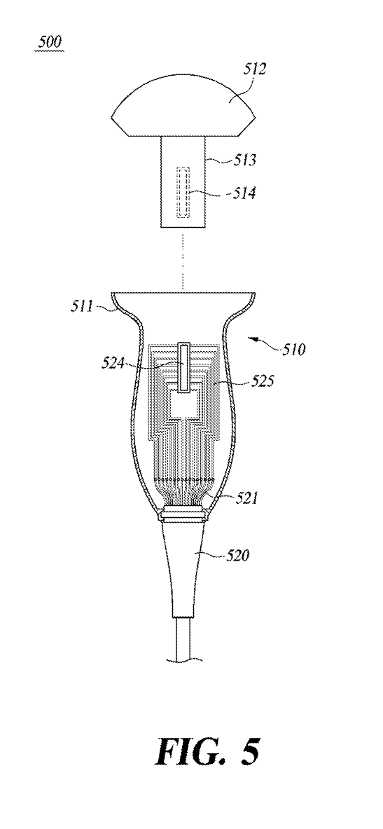

FIG. 5 is a schematic sectional view illustrating a scanhead of an ultrasound transducer according to a second embodiment of the present disclosure.

As shown in FIG. 5, the ultrasound transducer 500 according to the second embodiment of the present disclosure includes: a housing 511 which serves as a handle; an array 512; and a cable assembly 520.

The array 512 is disposed on a side surface of the housing 511 and comprises a plurality of piezoelectric elements (not shown) arranged in parallel to each other on a backing member. The array 512 further includes at least one first flexible circuit board 513 which is provided with a pattern circuit (not shown) electrically connected to the piezoelectric elements and a first connector 514 electrically connected to the pattern circuit. The cable assembly 520 includes a plurality of fine wires 521. A pattern circuit 525 is formed right on the interior surface of the housing 511 and electrically connected by the fine wires 521 to form signal paths. In addition, a mating second connector 524 is installed on the inner surface of the housing 511 and electrically connected to the pattern circuit 525.

Except that the pattern circuit 525 is directly formed on the inner surface of the housing 511 in the second embodiment without using a secondary flexible circuit board and that the second connector 524 to electrically connect with the pattern circuit 525 is installed on the inner surface of the housing 511, the remaining elements of the present disclosure are the same as those of the first embodiment described above. Therefore, detailed descriptions will not be repeated for the structures and functions of the same elements of the ultrasound transducer 500 as those of the ultrasound transducer 300.

The ultrasound transducer 500 according to the second embodiment of the present disclosure is characterized by a circuit pattern formed directly on the housing 511, obviating the conventional need for a PCB installation on the side of the cable assembly. To achieve this, injection-molded coating (MID; molded interconnect device) technology is used. With the injection-molded coating technology, the pattern circuit 525 can be precisely formed by laser processing and plating on the inner surface of the housing 511 that has been three-dimensionally molded, so that the pattern circuit 525 can be electrically connected to the circuit pattern of the first flexible circuit board 513.

Such patterning with injection-molded coating technology is disclosed by U.S. Pat. Nos. 6,490,168 and 5,825,633 and, therefore, further explanation thereof is deemed unnecessary in this description.

In the ultrasound transducer 500 according to the second embodiment of the present disclosure, the inner surface of the housing 511 is contoured to a predetermined profile on which the pattern circuit 525 is formed. Thereafter, the second connector 524 which is electrically connected to the pattern circuit 525 is installed in the housing 511 by soldering. When the second connector 524 is coupled to the first connector 514 of the flexible circuit board 513 of the array 512, signals can be transmitted between the flexible circuit board 513 of the array 512 and the fine wires 521 of the cable assembly 520 through the connectors 514 and 524. As such, the integral forming of the housing 511 and the pattern circuit 525 reduces the number of processes in assembling the scanhead 510 with fewer components to use. In addition, no more space is required for installation of the conventional PCB installation to reduce the thickness and size of the housing 511, resulting in a compact and slim ultrasound transducer.

The pattern circuit 525 may only be partially exposed for connection to the second connector 524, and the rest is coated with an insulator or the like so as to prevent an electrical short.

As described above, in the ultrasound transducer according to the second embodiment of the present disclosure, the pattern circuit 525 is directly and integrally formed on the housing 511 in place of the PCB from the cable assembly. Thereby, the degree of freedom in designing the length, width, thickness and shape of the housing 511 can be markedly enhanced, whereby an ultrasound transducer having a small-sized handle, which enables convenient grasping thereof, can be provided. Moreover, the housing is ergonomically designed so that even after a user manipulates the ultrasound transducer for an extended period of time, the user would be free from wrist pain or fatigue and, thus, more precise manipulation of the ultrasound transducer is achieved.

Although exemplary embodiments of the present disclosure have been described for illustrative purposes, those skilled in the art will appreciate that various modifications, additions and substitutions are possible, without departing from the essential characteristics of the disclosure. Therefore, exemplary embodiments of the present disclosure have been described for the sake of brevity and clarity. Accordingly, one of ordinary skill would understand the scope of the disclosure is not limited by the explicitly described above embodiments but by the claims and equivalents thereof.

### CROSS-REFERENCE TO RELATED APPLICATION

If applicable, this application claims priority under 35 U.S. §119(a) of Patent Application No. 10-2011-0147016, filed on Dec. 30, 2011 in Korea, the entire content of which is incorporated herein by reference. In addition, this non-provisional application claims priority in countries, other than the U.S., with the same reason based on the Korean Patent Application, the entire content of which is hereby incorporated by reference.

1. An ultrasound transducer, comprising:
a housing configured to serve as a handle;
an array mounted on a side surface of the housing and comprising:
a plurality of piezoelectric elements arranged in parallel to each other on a backing member, and
a flexible circuit board including a pattern circuit electrically connected to the piezoelectric elements; and
a cable assembly having a plurality of fine wires,
wherein signal paths are integrally formed on the housing for electrically connecting the pattern circuit of the flexible circuit board to the fine wires.

2. An ultrasound transducer, comprising:
a housing configured to serve as a handle;
an array mounted on a side surface of the housing and comprising:
a plurality of piezoelectric elements arranged in parallel to each other on a backing member, and
a first flexible circuit board including a first pattern circuit electrically connected to the piezoelectric elements; and
a cable assembly having a plurality of fine wires,
wherein the first flexible circuit board is provided with a first connector electrically connected to the first pattern circuit, and
wherein a second flexible circuit board is adhesively formed on the housing, the second flexible circuit board having a second pattern circuit electrically connected by the fine wires to form signal paths and a mating second connector electrically connected to the second pattern circuit.

3. The ultrasound transducer of claim 2, wherein the second flexible circuit board comprises:
a first polyimide film placed on a first adhesive layer provided on an inner surface of the housing, the first polyimide film forming one side boundary of the second flexible board;
a copper foil layer placed on the first polyimide film;
a second adhesive layer applied to the copper foil layer;
a second polyimide film placed on the second adhesive layer;
a pattern layer placed on the second polyimide film;
a third adhesive layer placed on the pattern layer; and
a third polyimide film placed on the third adhesive layer, the third polyimide film forming the other side boundary of the second flexible board.

4. The ultrasound transducer of claim 3, wherein the cable assembly has a jacket shield partially drawn to form a protruding jacket shield extension for making an electrical connection by soldering with an exposed portion of the copper foil layer.

5. The ultrasound transducer of claim 3, wherein the pattern layer is partially exposed for allowing the third polyimide film to be mounted with the second connector electrically connected to the second pattern circuit of the pattern layer.

6. The ultrasound transducer of claim 5, wherein the first connector provided on the first flexible circuit board of the array is coupled to the second connector for establishing a wired connection.

7. An ultrasound transducer, comprising:
a housing configured to serve as a handle;
an array mounted on a side surface of the housing and comprising:
a plurality of piezoelectric elements arranged in parallel to each other on a backing member, and
a first flexible circuit board including a first pattern circuit electrically connected to the piezoelectric elements; and
a cable assembly having a plurality of fine wires,
wherein the first flexible circuit board is provided with a first connector electrically connected to the first pattern circuit, and
a second pattern circuit is directly patterned on an inner surface of the housing and electrically connected by the fine wires to form signal paths, and a mating second connector is mounted on the inner surface of the housing and electrically connected to the second pattern circuit.

8. The ultrasound transducer of claim 7, wherein the patterning on the inner surface of the housing is performed by injection-molded coating (MID: molded interconnect device).

9. The ultrasound transducer of claim 7, wherein the second pattern circuit formed on the housing is connected to the second connector by soldering.

10. The ultrasound transducer of claim 7, wherein the first connector provided on the first flexible circuit board of the array is coupled to the second connector for establishing a wired connection.
